(19) United States
(12) Patent Application Publication
(10) Pub. No.: US 2026/0300970 A1
(43) Pub. Date: Oct. 1, 2026

(54) BLOCKCHAIN ESCROW

(71) Applicant: Unstoppable Domains Inc., Las Vegas, NV (US)

(72) Inventors: Matthew Everett Gould, Atlanta, GA (US); Mykyta Shatilo, Lisbon (PT); Lisa Seacat DeLuca, Bozeman, MT (US)

(21) Appl. No.: 19/096,212

(22) Filed: Mar. 31, 2025

(51) Int. Cl. G06Q 20/40; G06Q 20/06; G06Q 20/38; G06Q 30/0645

(52) U.S. Cl. CPC G06Q 20/40; G06Q 20/065; G06Q 20/3825; G06Q 30/0645; G06Q 2220/00

(57) ABSTRACT

A request to establish a digital escrow for a transfer of a domain name is received. A blockchain smart contract for the transfer is implemented. A first cryptographically signed authorization associated with a registered owner of the domain name is received. A second cryptographically signed authorization associated with a target recipient of the domain name is received. A digital token associated with the domain name is placed in the digital escrow. One or more terms of the blockchain smart contract are automatically detected as having been satisfied. In response to detecting that the one or more terms of the blockchain smart contract has been satisfied, the digital token associated with the domain name in the digital escrow is released to the target recipient of the domain name.

### BACKGROUND OF THE INVENTION

Transferring ownership of a domain name between a buyer and a seller typically involves a complex multi-step process prone to failure and fraud. Safeguards are added when the process is performed using an escrow service. For example, an escrow service can hold the payment for a domain name until the domain transfer is successfully completed. While escrow services add a layer of protection, they still require a significant level of trust among the buyer, seller, and escrow provider. Traditional escrow services also introduce security risks, such as ensuring that both the domain name and the payment are transferred securely and on time. Therefore, there is a need for a more secure domain transfer process that minimizes security risks while also reducing the reliance on blind trust between parties.

### BRIEF DESCRIPTION OF THE DRAWINGS

Various embodiments of the invention are disclosed in the following detailed description and the accompanying drawings.

FIG. 1 is a block diagram illustrating an embodiment of a computing infrastructure for a secure blockchain-based digital escrow service.

FIG. 2 is a block diagram illustrating an embodiment of a blockchain-based digital escrow service for securely transferring domain names and domain name properties.

FIG. 3 is a flow chart illustrating an embodiment of a process for securely transferring a domain name using a blockchain-based digital escrow service.

FIG. 4 is a flow chart illustrating an embodiment of a process for initiating the transfer of a domain name using a blockchain-based digital escrow service.

FIG. 5 is a flow chart illustrating an embodiment of a process for closing a digital escrow using a blockchain-based digital escrow service.

FIG. 6 is a flow chart illustrating an embodiment of a process for performing an escrow cancellation using a blockchain-based digital escrow service.

FIG. 7 is a sequence diagram illustrating an embodiment of a process for closing a digital escrow using a blockchain-based digital escrow service.

FIG. 8 is a functional diagram illustrating a programmed computer system for securing and efficiently escrowing an off-chain asset using a blockchain-based digital escrow service.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A blockchain escrow solution is disclosed. Using the disclosed blockchain escrow techniques and systems, a Domain Name System (DNS) domain name and/or associated properties and/or rights of a domain name can be securely exchanged between a buyer and a seller, minimizing the security risks inherent from traditional escrow services while also offering an improvement in the efficiency and speed of the transfer. The disclosed blockchain-based digital escrow service utilizes a blockchain smart contract to verify that terms for a domain name transfer have been met by the buyer before allowing the domain name to be transferred from the seller to the buyer. In various embodiments, the blockchain-based digital escrow service further utilizes an on-chain representation of the domain name to prove ownership of the off-chain domain name. For example, while in escrow, a unique on-chain representation of the domain name is held by the escrow smart contract, ensuring that the seller owns the domain name in question and that ownership can be legitimately transferred to the buyer. This on-chain representation of the domain name significantly improves the security of the escrow service limiting the level of blind trust required by the parties. Similarly, the blockchain-based digital escrow service utilizes an escrow smart contract to verify that payment terms required by the seller to complete the transfer have been completed by the buyer. When the escrow smart contract determines that the agreed upon terms have been satisfied, the escrow smart contract then releases the on-chain representation of the domain name to the buyer. Using the released on-chain representation of the domain name, the buyer can then claim ownership of the off-chain version of the domain name. By utilizing an escrow smart contract to bridge the seller and buyer parties, delays in verifying ownership and satisfaction of agreement terms, such as confirmation of payment terms, can be significantly reduced or eliminated. The disclosed blockchain escrow solution thereby allows for the automated transfer of domain names in an efficient and timely manner. Moreover, in the event the terms are never satisfied, the transfer can be securely voided and partial actions reversed. For example, the off-chain version of the domain name can be released back to the seller and any pending payments returned to the buyer.

Although the disclosed invention is described with respect to DNS domain names, the secure blockchain escrow transfer can be applied for other assets, both digital and non-digital assets. Moreover, the transfer of an asset from a buyer to a seller is not limited to the transfer of ownership rights—other rights and/or properties of an asset can be transferred using the disclosed blockchain escrow solution without relinquishing full ownership. For example, the right to control off-chain DNS records for a domain name can be transferred for an agreed upon period without transferring full ownership of a domain name as long as agreed upon terms are met. In various embodiments, by supporting the transfer of selective rights, permissions, and/or properties associated with an asset, the disclosed blockchain escrow solution provides the ability to implement complex relationships, such as lessor/lessee relationships, while enforcing breakup terms in the event that the terms of the agreement are broken. For example, rights associated with a domain name can be leased to a lessee until the lease expires or the terms of the lease are broken.

In some embodiments, a request to establish a digital escrow for a transfer of a domain name is received. For example, a blockchain-based digital escrow service receives a request to transfer a domain name from a seller to a buyer using the provided digital escrow service. In some embodiments, a blockchain smart contract is implemented for the transfer. For example, a blockchain smart contract is established that can bridge the seller and buyer parties, allowing for the secure transfer of the domain name. In some embodiments, a first cryptographically signed authorization associated with a registered owner of the domain name is received. For example, a domain name owner provides a signed authorization agreeing to use the digital escrow service and to the transfer terms. The owner's authorization may include information to help verify ownership of the domain name. In some embodiments, a second cryptographically signed authorization associated with a target recipient of the domain name is received. For example, the buyer also provides a signed authorization agreeing to use the digital escrow service and to the transfer terms. The buyer's authorization may include information on the terms agreed to including information on purchase terms and information to verify ownership of assets used to meet the purchase terms.

In some embodiments, a digital token associated with the domain name is placed in the digital escrow. For example, a digital on-chain representation of the off-chain domain name is held in escrow and used to complete the transfer of the off-chain domain name when the escrow terms have been met. This digital token may be transferred to the blockchain smart contract until the escrow is complete, and ownership of the digital token can be required to gain ownership of the domain name. In some embodiments, one or more terms of the blockchain smart contract are automatically detected as having been satisfied. For example, the blockchain smart contract can actively determine when the terms of the transfer agreement have been satisfied including by verifying that payment terms have been met. In some embodiments, in response to detecting that the one or more terms of the blockchain smart contract has been satisfied, the digital token associated with the domain name in the digital escrow is released to the target recipient of the domain name. For example, the digital token is released by the smart contract to the buyer once the smart contract verifies that the terms of the agreement have been met. Using the digital token, the buyer can retain ownership of the off-chain domain name. For example, the buyer provides the digital token, now owned by the buyer, to the DNS registrar to claim the off-chain domain name.

With the disclosed blockchain escrow techniques and systems, specific technical problems of trust and security vulnerabilities inherent in traditional escrow arrangements, which rely on centralized third-party intermediaries, are addressed. Traditional technical solutions result in slow processing, susceptibility to fraud, susceptibility to human error, and high operational costs. Unlike conventional escrow methods that involve manual oversight, paperwork, and centralized storage systems vulnerable to manipulation or single points of failure, the present invention implements a blockchain-based digital escrow with the technical advantages of decentralized smart contracts and cryptographic verification. The innovative combination of blockchain immutability, distributed ledger technology, and self-executing escrow smart contracts provides a technical solution that automates traditional and non-blockchain digital escrow management, guarantees transaction integrity, and substantially reduces the risk of unauthorized access or data tampering. By shifting from manual or supervised intervention and centralized trust models to a secure, automated, and distributed approach, the claimed invention significantly improves transaction speed, reliability, auditability, and overall data security. Importantly, the utilization of a blockchain smart escrow contract provides a practical technological advancement beyond the abstract or conventional implementations previously used. For example, the invention's blockchain smart escrow contract introduces a cryptographic verification mechanism that automatically and dynamically authenticates parties and transaction terms and conditions before securely releasing funds and assets, preventing unauthorized access or manipulation and adapting to current market conditions. The invention further provides a technical advancement over conventional escrow solutions by improving the security, transparency, and automation of escrow services through the integration of escrow smart contracts and blockchain consensus mechanisms.

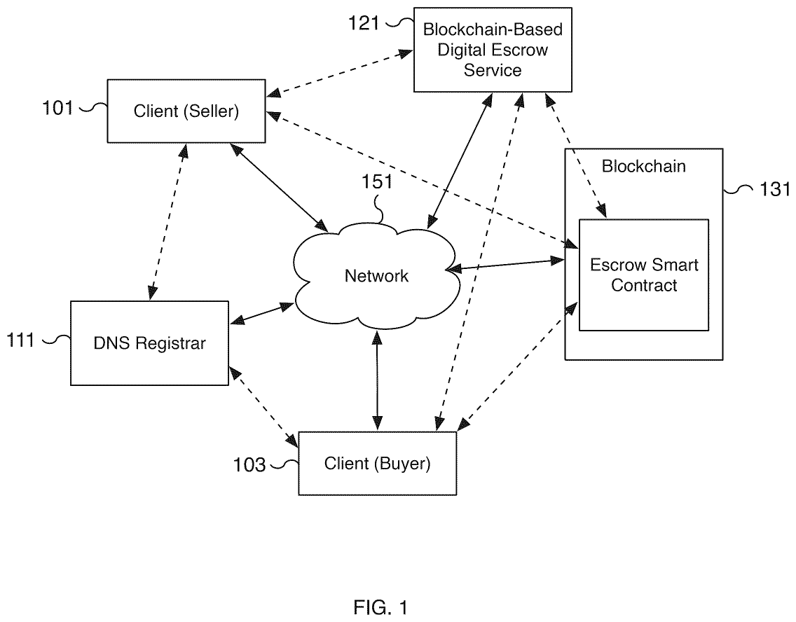

FIG. 1 is a block diagram illustrating an embodiment of a computing infrastructure for a secure blockchain-based digital escrow service. In the example shown, clients 101 and 103 are network clients that correspond to a seller and buyer, respectively, of an off-chain domain name managed by DNS registrar 111. Blockchain-based digital escrow service 121 is a digital escrow service that utilizes blockchain 131 and the escrow smart contract of blockchain 131 to securely transfer domain names between parties. Clients 101 and 103 utilize blockchain-based digital escrow service 121 to complete their domain name transaction. Clients 101 and 103, DNS registrar 111, blockchain-based digital escrow service 121, and blockchain 131 are each communicatively connected to one another via network 151. The dotted lines between the different entities of FIG. 1 represent effective lines of communication between the different entities that are enabled by network 151. Network 151 can be a public or private network. In some embodiments, network 151 is a public network such as the Internet.

In some embodiments, clients 101 and 103 are each a network computing device and correspond to a seller and buyer, respectively, of an off-chain domain name. The client devices can correspond to different types of computing devices such as a desktop computer, a laptop, a mobile device, a tablet, a smart home device, a wearable device, or other network computing devices. Client 101 corresponds to a user that is the seller and owner of a domain name and client 103 corresponds to a user that is the buyer or recipient of the domain name. For example, using client 101, the seller can agree to terms for selling a domain name to another user such as the user of client 103. In the example shown, client 103 corresponds to the recipient user of a domain name transfer who similarly agrees to the transaction terms. In various embodiments, the transfer of the domain name is managed by blockchain-based digital escrow service 121 using blockchain 131.

In some embodiments, DNS registrar 111 is a DNS service for managing an off-chain domain name owned by the user of client 101. Using DNS registrar 111, an authorized user can manage a domain name and its associated properties. For example, an authorized user can claim ownership of a corresponding off-chain domain name. configure DNS records associated with the domain name, manage forwarding records for the domain name, and/or create subdomains for the domain name, among other management actions. In various embodiments, DNS registrar 111 is enabled to allow a transfer of an off-chain domain name and/or its properties when presented with ownership of a corresponding on-chain representation for the same domain name. For example, using the on-chain representation of a domain name, a client such as client 103 can claim the corresponding off-chain domain name.

In some embodiments, blockchain-based digital escrow service 121 is a service that manages the transfer of domain names and/or properties or rights of domain names between parties, such as between a seller and buyer of an off-chain domain name. Blockchain-based digital escrow service 121 utilizes an escrow smart contract of blockchain 131 to allow for the secure and efficient transfer of off-chain domains managed by DNS registrar 111. For example, when two parties agree on terms for a domain name transfer, blockchain-based digital escrow service 121 receives from each party an acknowledgement to the agreed transfer and terms. Using an on-chain representation of the domain name, blockchain-based digital escrow service 121 will facilitate the secure transfer of the off-chain domain name once the terms have been met. In various embodiments, an escrow smart contract deployed on blockchain 131, such as by blockchain-based digital escrow service 121, manages the on-chain representation of the domain name and determines when the terms have been met. When the terms have been met, the on-chain representation of the domain name is released to the buyer allowing the buyer to claim the off-chain domain name. In some embodiments, the parties are clients 101 and 103 and the corresponding acknowledgements of the transfer terms by the seller and buyer include receiving a cryptographically signed authorization from each party. In some embodiments, the on-chain representation of the domain name is a digital token, such as a token minted on blockchain 131, that is temporarily held by an intermediary, such as by an escrow smart contract, until the terms of the transfer have been met.

In some embodiments, blockchain 131 corresponds to a blockchain network service and can represent a public digital ledger distributed across multiple computing devices. Blockchain 131 is used for various purposes including for verifying transactions such as transactions of digital currencies or assets, and for enabling smart contracts such as to enforce terms as part of a digital escrow service. In the example shown, blockchain 131 includes an escrow smart contract for use with blockchain-based digital escrow service 121 that can automatically determine if terms of an agreement are met and enable the transfer of an off-chain domain name between parties. The escrow smart contract can utilize an on-chain representation of the domain name to allow for the secure transfer of the off-chain domain name. In some embodiments, the escrow smart contract of blockchain 131 is a self-executing program stored on a blockchain 131 deployed by blockchain-based digital escrow service 121.

In various embodiments, the components shown in FIG. 1 may exist in various combinations of software programs and/or hardware machines. Although single instances of some components have been shown to simplify the diagram, additional instances of any of the components shown in FIG. 1 may exist. For example, blockchain-based digital escrow service 121 and blockchain 131 can each include one or more servers including distributed servers as well as shared or partially shared servers. As additional examples, clients 101 and 103 are just one example of a seller and buyer pair for transferring a domain name via a digital escrow service, such as blockchain-based digital escrow service 121. In some embodiments, components not shown in FIG. 1 may also exist.

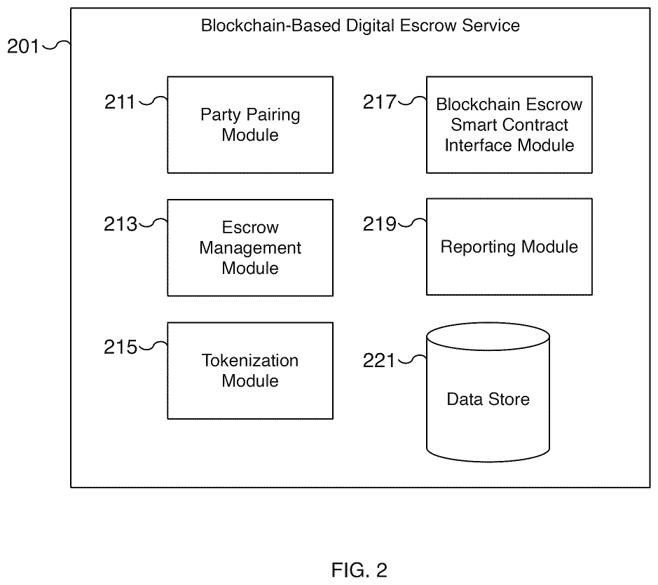

FIG. 2 is a block diagram illustrating an embodiment of a blockchain-based digital escrow service for securely transferring domain names and domain name properties. For example, using a blockchain-based digital escrow service, a domain name or properties/rights associated with a domain name can be securely and efficiently transferred between parties. In the example shown, blockchain-based digital escrow service 201 includes party pairing module 211, escrow management module 213, tokenization module 215, blockchain escrow smart contract interface module 217, reporting module 219, and data store 221. In various embodiments, blockchain-based digital escrow service 201 implements the disclosed blockchain escrow solutions more securely and efficiently than existing solutions and without requiring the levels of blind trust inherent in traditional escrow solutions. In some embodiments, blockchain-based digital escrow service 201 is blockchain-based digital escrow service 121 of FIG. 1.

In some embodiments, party pairing module 211 is a processing module for pairing sellers and buyers. In various embodiments, the seller may be represented by one or more parties and, similarly, the buyer may be represented by one or more parties. Although party pairing module 211 typically pairs sellers with buyers, party pairing module 211 can similarly pair parties in other relationships such as a lessor/lessee relationship. In some embodiments, party pairing module 211 helps to coordinate the terms for a transaction that allow the different parties to be paired together. For example, party pairing module 211 can be used to coordinate the offer of a domain name for sale (or lease or another related offer) and the terms for a potential transaction. Similarly, party pairing module 211 can be used to coordinate the offer of a domain name for purchase (or lease or another related offer) and the terms for the potential transaction. Using party pairing module 211, parties can be matched to initiate an agreement based on defined terms that utilizes blockchain-based digital escrow service 201 as a digital escrow service for the completion of a transaction.

In some embodiments, escrow management module 213 is a processing module for managing an escrowed transaction. For example, using escrow management module 213, a potential transaction can be completed both securely and efficiently with limited trust required between the involved parties. Escrow management module 213 can manage and retain signed acknowledgements agreeing to the terms of a transfer, verify ownership of an asset such as ownership of a domain name or rights associated with a domain name, and verify the terms of the transaction (such as payment terms) have been completed. Once the terms have been completed, escrow management module 213 can release the escrowed asset to the buyer. In some embodiments, escrow management module 213 helps manage an on-chain token associated with the off-chain asset, such as an on-chain representation of an off-chain domain name. In various embodiments, escrow management module 213 utilizes other components of blockchain-based digital escrow service 201 such as blockchain escrow smart contract interface module 217 to help perform the digital escrow of a transaction.

In some embodiments, tokenization module 215 is a processing module for tokenizing and verifying on-chain tokens of off-chain assets and/or rights/properties associated with assets such as off-chain assets. For example, using tokenization module 215, an on-chain representation of an off-chain domain name can be minted and used to confer ownership of the off-chain domain. In some embodiments, tokenization module 215 can be used to confirm the existence of an on-chain token corresponding to an off-chain asset. For example, if no corresponding on-chain token exists, a new on-chain token can be minted for the off-chain asset. In some embodiments, tokenization module 215 is further used to map between off-chain assets and their corresponding on-chain tokens.

In some embodiments, blockchain escrow smart contract interface module 217 is a processing module for interfacing with a blockchain escrow smart contract such as the escrow smart contract of blockchain 131 of FIG. 1. Using blockchain escrow smart contract interface module 217, a transaction for an off-chain asset can be performed under digital escrow using an escrow smart contract to enforce the terms of the transaction. For example, blockchain escrow smart contract interface module 217 can be used to initiate the secure transfer of an off-chain asset from one party to another using an escrow smart contract and an on-chain representation of the off-chain asset. Moreover, blockchain escrow smart contract interface module 217 can be used to help monitor the transaction such as to determine when the terms of a transaction have been met. For example, using blockchain escrow smart contract interface module 217, an escrow smart contract can be queried to set the terms of an agreement and to monitor the completion status of the terms. In some embodiments, blockchain escrow smart contract interface module 217 is further used to deploy the escrow smart contract to the appropriate blockchain.

In some embodiments, reporting module 219 is a processing module for reporting data on transactions including potential transactions and escrowed transactions. For example, using reporting module 219, the status of a domain name in escrow can be reported such as via a dashboard, an application programming interface (API), or another similar service. Reporting module 219 can be used to report potential transactions (such as offers for sale or purchase) and/or completed transactions along with information associated with the transactions. In various embodiments, reporting module 219 can provide the information via a dashboard or another similar interactive interface. In some embodiments, reporting module 219 writes the reporting data to a blockchain such as blockchain 131 of FIG. 1.

In some embodiments, data store 221 corresponds to one or more data sources used by blockchain-based digital escrow service 201 and its components. Data store 221 can include local and remote or distributed storage. In some embodiments, data store 221 is used for the secure storage of transaction acknowledgements, terms for a transaction, ownership and rights records associated with an asset such as a domain name, and/or mappings between on-chain tokens to off-chain assets, among other data storage needs of blockchain-based digital escrow service 201. Data store 221 can also be used for storing user profile information such as transaction history, account balances, configuration settings, and account information including contact information for users such as past and prospective sellers and buyers, among other data. In various embodiments, data store 221 includes a form of secure storage and utilizes various forms of encryption methods to protect against unauthorized access.

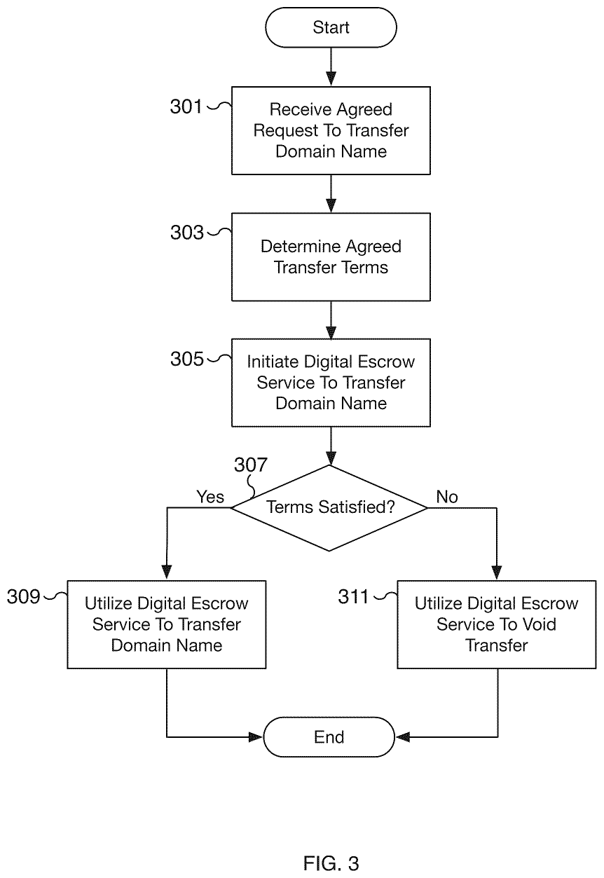

FIG. 3 is a flow chart illustrating an embodiment of a process for securely transferring a domain name using a blockchain-based digital escrow service. Using the process of FIG. 3, a domain name and/or properties or rights associated with a domain name can be securely and efficiently transferred between parties without requiring the levels of blind trust and security risks associated with traditional escrow services. For example, the off-chain domain name being transferred is linked to an on-chain representation of the domain name that can be held securely by a blockchain escrow smart contract until the terms of the agreement have been met. Only once the terms have been met, as determined by the blockchain escrow smart contract, is the on-chain representation of the domain name released to the buyer, allowing the buyer to claim the off-chain domain name. In some embodiments, the blockchain-based digital escrow service is blockchain-based digital escrow service 121 of FIG. 1 and/or blockchain-based digital escrow service 201 of FIG. 2. In some embodiments, the blockchain escrow smart contract is the escrow smart contract of blockchain 131 of FIG. 1.

At 301, an agreed request to transfer a domain name is received. For example, a request to transfer a domain name is received. In some embodiments, the received request includes the parties involved in the request, such as a seller and buyer or a lessor and lessee. In various embodiments, the request may correspond to a purchase initiated by a buyer in response to an offer presented by a seller. Similarly, the request may correspond to an agreement to sell a domain name agreed to by a seller in response to purchase terms presented by a buyer. In various embodiments, the agreed request can be initiated via a marketplace such as an online marketplace for domain names and/or rights or properties associated for domain names. For example, via an online marketplace, an owner of a domain name can offer a domain name for sale, can offer the right to use a domain name for a period of time such as in a lease arrangement, and/or can offer other properties and/or rights associated with a domain name for purchase or lease. As another example, via an online marketplace, a prospective buyer can provide an offer to purchase a domain name that can be accepted by the owner of a domain name. In some embodiments, the online marketplace interfaces with the blockchain-based digital escrow service and initiates sending the agreed request to transfer a domain name to the blockchain-based digital escrow service.

At 303, the agreed transfer terms are determined. For example, the terms of the agreement for the agreed request to transfer a domain from step 301 are determined. In some embodiments, the terms are included in the request received at 301. In various embodiments, the terms are conditions that must be satisfied in order for a domain name or another asset or right to transfer from the seller to the buyer. For example, for an escrowed domain name sale, once the determined terms are met, the domain name is released from the seller to the buyer. In various embodiments, the terms can be purchase terms and may correspond to a purchase amount to be paid for a domain name. In some embodiments, the purchase terms can include cryptographic assets and the purchase terms may be satisfied based on the current value of cryptographic assets. For example, in some scenarios, cryptocurrencies and/or non-fungible tokens (NTFs) can be used for completing a purchase. In some embodiments, the transfer terms include one or more time constraints. For example, a time constraint included in the agreed transfer terms can specify a time requirement for completing the digital escrow, such as a maximum amount of time allowed for meeting payment terms. The failure to meet a time constraint can be used to trigger the cancellation of the digital escrow and result in voiding the transfer, such as the transfer of a domain name. In some embodiments, the time constraint included in the agreed terms is associated with a lease arrangement for a right associated with the asset. For example, the time constraint can describe a lease arrangement for the use of a domain name for a certain period of time. The right may confer certain management rights for modifying certain DNS records of the domain name, such as forwarding records.

At 305, a digital escrow service is initiated to transfer the domain name. For example, with the parties and terms determined, a digital escrow service is initiated to perform a digital escrow of the item for transfer. By escrowing the item using a blockchain-based digital escrow service, the item can be more securely and efficiently transferred. In the event the terms are met, the item is released from the seller to the buyer. In the event the terms are not met, the item can be released back to the seller and any pending payments can be returned to the buyer. In various embodiments, the blockchain-based digital escrow service utilizes an on-chain representation of the item and an escrow smart contract to ensure that the item can be released to the seller when the agreed upon terms have been met.

At 307, a determination is made whether the terms of the agreement are satisfied. In the event the terms of the agreement are satisfied, processing proceeds to 309. For example, an escrow smart contract determines that the terms have been satisfied allowing the domain to be released to the buyer and payment to be released to the seller. In the event the terms of the agreement are not satisfied, processing proceeds to 311. For example, an escrow smart contract can determine that the terms have not been satisfied within appropriate constraints, such as within a certain time frame, and the transfer is voided.

At 309, the digital escrow service is utilized to transfer the domain name. For example, once the payment terms have been met, the escrow smart contract releases the on-chain representation of the domain name to the buyer. Using the on-chain representation of the domain name, the buyer can claim the off-chain domain name from the appropriate DNS registrar. In some embodiments, the escrow smart contract also holds and then releases payment to the seller, such as assigning assets such as cryptographic assets or another form of payment to the seller.

At 311, the digital escrow service is utilized to void the transfer. For example, once the payment terms have not been met within appropriate constraints (such as time-based constraints), the escrow smart contract voids the transfer by releasing the on-chain representation of the domain name back to the seller. Using the on-chain representation of the domain name, the seller can reclaim the off-chain domain name from the appropriate DNS registrar. The escrow smart contract can also return any pending payments back to the buyer, such as assigning assets such as cryptographic assets or another form of payment, back to the buyer.

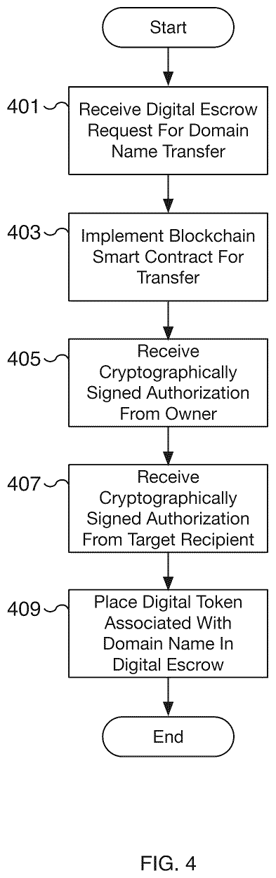

FIG. 4 is a flow chart illustrating an embodiment of a process for initiating the transfer of a domain name using a blockchain-based digital escrow service. Using the process of FIG. 4, a domain name and/or properties or rights associated with a domain name can be securely and efficiently transferred between parties without requiring the levels of blind trust and security risks associated with traditional escrow services. By linking the off-chain domain name to an on-chain representation of the domain name, the off-chain domain name is securely held in escrow while the terms are being met. In various embodiments, while the transaction is in escrow, the on-chain representation of the domain name is an on-chain token that is held securely by a blockchain escrow smart contract of the blockchain-based digital escrow service. Once the terms of the agreement have been met, the on-chain token is assigned to the buyer and used to release the off-chain domain name to the buyer. In some embodiments, the process of FIG. 4 is performed at 301, 303, and/or 305 of FIG. 3 by a blockchain-based digital escrow service and an associated blockchain escrow smart contract. In some embodiments, the blockchain-based digital escrow service is blockchain-based digital escrow service 121 of FIG. 1 and/or blockchain-based digital escrow service 201 of FIG. 2. In some embodiments, the blockchain escrow smart contract is the escrow smart contract of blockchain 131 of FIG. 1.

At 401, a digital escrow request is received for a domain name transfer. For example, a request to initiate a digital escrow is received by the blockchain-based digital escrow service. In some embodiments, the request is provided by an online marketplace associated with the blockchain-based digital escrow service. The request can include the parties involved and the terms of the agreement. For example, the request can specify a seller party, a buyer party, the domain name or asset for sale, and payment terms for completing the sale. In some embodiments, the request is for a lease or another transfer arrangement and may involve the transfer of a right or property of an asset rather than for the complete sale of an asset. In some embodiments, the blockchain-based digital escrow service allows for multiple parties to participate as either the seller or buyer.

At 403, a blockchain smart contract is implemented for the transfer. For example, the blockchain-based digital escrow service utilizes a blockchain escrow smart contract to help manage the digital escrow. If an existing escrow smart contract does not exist, one is deployed to the blockchain. Once deployed, the blockchain-based digital escrow service can interface with the escrow smart contract, for example, by reading and writing to the blockchain. Example interfaces can include a web interface, command-line tools, scripts, and/or other smart contract interfaces.

At 405, a cryptographically signed authorization is received from the owner. For example, in response to a request to approve the digital escrow, a cryptographically signed authorization is provided by the owner of the domain name. In various embodiments, the escrow smart contract provides the request to approve the digital escrow and receives the signed authorization from the owner. Once received, the escrow smart contract can verify the authenticity and integrity of the signed authorization. In various embodiments, the owner corresponds to the seller of the domain name.

At 407, a cryptographically signed authorization is received from the target recipient. For example, in response to a request to approve the digital escrow, a cryptographically signed authorization is provided by the target recipient of the domain name. In various embodiments, the escrow smart contract provides the request to approve the digital escrow and receives the signed authorization from the target recipient. Once received, the escrow smart contract can verify the authenticity and integrity of the signed authorization. In various embodiments, the target recipient corresponds to the buyer of the domain name.

At 409, a digital token associated with the domain name is placed in digital escrow. For example, ownership of an on-chain representation of the off-chain domain name is transferred to the escrow smart contract. In some embodiments, the on-chain representation of the off-chain domain is a digital token. In the event no digital token for the off-chain domain name exists, one is minted on the blockchain and ownership assigned to the escrow smart contract. In some embodiments, rather than transferring ownership, the existing token is burned and a new one minted and ownership assigned to the escrow smart contract. While the domain name is in escrow, the escrow smart contract maintains ownership of the corresponding on-chain digital token. In various embodiments, the digital token can convey ownership of the off-chain domain name to the owner of the digital token.

In various embodiments, the digital token is a unique non-fungible token that allows its owner to claim rights, such as ownership, usage, or other rights, associated with its corresponding off-chain asset, such as an off-chain domain name. The digital token therefore unlocks rights associated with its off-chain asset and can be presented to services, such as a DNS registrar, to claim the appropriate rights for the off-chain asset. For example, using the on-chain token corresponding to ownership of an off-chain domain name, the owner of the on-chain token can claim ownership of the off-chain domain name via the appropriate DNS registrar.

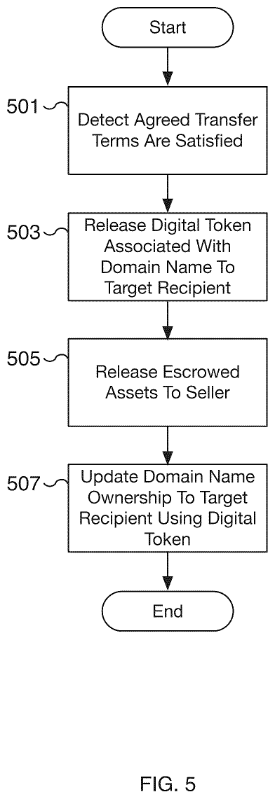

FIG. 5 is a flow chart illustrating an embodiment of a process for closing a digital escrow using a blockchain-based digital escrow service. Using the process of FIG. 5, a digital escrow process is closed when an escrow smart contract of a blockchain-based digital escrow service determines that the terms of the agreement have been met and consequently transfers ownership of the on-chain representation of the domain name to the buyer and releases the escrowed assets, such as the purchase funds, to the seller. Using the on-chain representation of the domain name, the buyer can claim ownership of the off-chain domain name. In various embodiments, the escrow smart contract can continuously monitor the status of the agreement terms, initiating the closing procedures only when the terms have been met. In some embodiments, the process of FIG. 5 is performed at 307 and/or 309 of FIG. 3 by a blockchain-based digital escrow service and an associated blockchain escrow smart contract. In some embodiments, the blockchain-based digital escrow service is blockchain-based digital escrow service 121 of FIG. 1 and/or blockchain-based digital escrow service 201 of FIG. 2. In some embodiments, the blockchain escrow smart contract is the escrow smart contract of blockchain 131 of FIG. 1.

At 501, satisfaction of the agreed transfer terms is detected. For example, the escrow smart contract of the blockchain-based digital escrow service detects and determines that the terms agreed to by the parties have been satisfied. In various embodiments, the escrow smart contract is self-executing and runs on a blockchain. The escrow smart contract can be automated and trustless, executing when required to determine when all the terms of the agreement have been met. In some embodiments, the terms include payment and ownership terms. For example, the escrow smart contract can evaluate whether the agreed to payment terms have been met. Payment can be made using currency including cryptocurrency or cryptographic assets, and the escrow smart contract can evaluate the valuation of the pending payments. In various embodiments, the payments are made to the escrow smart contract, which holds ownership of the payments until all terms are met. Similarly, the escrow smart contract may determine ownership of the asset for sale, such as ownership of a domain name. For example, the escrow smart contract can verify that the seller is the actual owner and further take ownership of the domain name while the asset is in escrow. In some embodiments, rather than taking complete ownership of the domain name while in escrow, the ability to change ownership of the domain name is locked. For example, the escrow smart contract can take ownership of an on-chain representation of the asset, such as a digital token corresponding to the off-chain domain name. By owning the on-chain representation of the domain name, modifications to the off-chain domain name (such as a change in ownership) are locked while the asset is in escrow.

At 503, the digital token associated with the domain name is released to the target recipient. For example, ownership of the digital token is assigned to the target recipient. In some embodiments, the token is transferred from the escrow smart contract to a wallet associated with the buyer. The wallet address of the target recipient can be provided as part of a signed authorization from the target recipient agreeing to the terms of the transfer. Ownership of the digital token allows the target recipient to claim the off-chain domain name.

At 505, escrowed assets are released to the seller. For example, assets provided by the target recipient for the owner in exchange for the domain name as part of the agreed terms are escrowed assets that are released to the seller. In various embodiments, the escrowed assets are held by the escrow smart contract and transferred to a wallet associated with the seller. By releasing the escrowed assets, the payment provided by the buyer is transferred to the seller.

At 507, domain name ownership is updated to the target recipient using the digital token. For example, the target recipient can claim ownership of the off-chain domain name by presenting the digital token acquired at 503 to the appropriate DNS registrar. In various embodiments, once the DNS registrar validates the digital token and its ownership, ownership of the off-chain domain name can be assigned to the target recipient. In some embodiments, the digital token is used to manage the domain name via the DNS registrar, such as to change DNS records including forwarding records. In various embodiments, each digital token can have a corresponding set of rights associated with a domain name such as full ownership rights, usage rights, and/or records administration rights, among others. For example, a bundle of rights associated with a domain name (or another off-chain asset) can be assigned to different digital tokens, which each convey the appropriate different sets of rights.

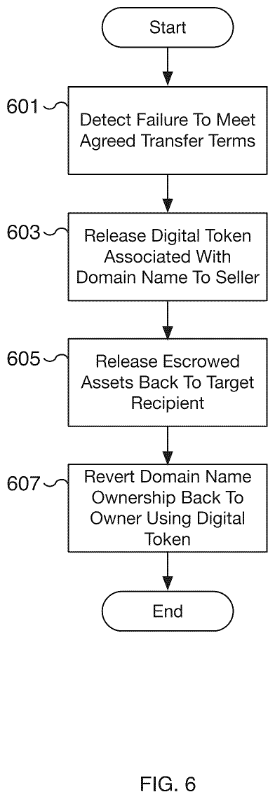

FIG. 6 is a flow chart illustrating an embodiment of a process for performing an escrow cancellation using a blockchain-based digital escrow service. Using the process of FIG. 6, a digital escrow is cancelled when an escrow smart contract of a blockchain-based digital escrow service determines that the terms of the agreement have not been met within the appropriate constraints. The escrow cancellation results in the ownership of the domain name reverting back to the seller (or owner of the domain name) and any pending escrowed payments made by the buyer are returned back to the buyer (or original target recipient of the domain name). Using the on-chain representation of the domain name, the digital token can be released back to the owner, allowing the owner to reclaim or unlock the off-chain domain. Similarly, any escrowed assets provided by the buyer can be released back to the buyer. In various embodiments, the escrow smart contract can continuously monitor the status of the agreement terms, and in the event the terms have not been appropriately met, such as within an appropriate time frame, the escrow is cancelled. In some embodiments, other triggering events can cancel the digital escrow, such as one of the parties backing out of the agreement or a third-party intervening in the transaction. In some embodiments, the process of FIG. 6 is performed at 307 and/or 311 of FIG. 3 by a blockchain-based digital escrow service and an associated blockchain escrow smart contract. In some embodiments, the blockchain-based digital escrow service is blockchain-based digital escrow service 121 of FIG. 1 and/or blockchain-based digital escrow service 201 of FIG. 2. In some embodiments, the blockchain escrow smart contract is the escrow smart contract of blockchain 131 of FIG. 1.

At 601, a failure to meet the agreed transfer terms is detected. For example, the escrow smart contract of the blockchain-based digital escrow service detects and determines that the terms agreed to by the parties have not been (or will never be) satisfied. The failure can be triggered by different events and/or constrains. For example, the agreed terms may dictate that payment must be made within a certain time frame and the allowed time frame has elapsed. Other events can cancel the escrow as well, such as a revocation of the agreement to the transfer by either party. In some embodiments, a third-party can intervene to cancel the transfer. In various embodiments, the escrow smart contract determines that the terms will not be met and begins to void and reverse the transactions, as necessary. For example, the escrow smart contract may hold full or partial payment provided by the buyer and/or own the on-chain digital token corresponding to the off-chain asset. To properly void the transaction and cancel the escrow, the payments made by the buyer should be returned to the buyer and the off-chain asset should be unlocked, allowing the owner to reestablish control of the off-chain asset.

At 603, the digital token associated with domain name is released to the seller. For example, ownership of the digital token is assigned back to the seller. In some embodiments, the token is transferred from the escrow smart contract to a wallet associated with the seller. The wallet address of the seller can be provided as part of a signed authorization from the seller agreeing to the terms of the transfer. Ownership of the digital token allows the seller to reclaim (or unlock) the off-chain domain name.

At 605, escrowed assets are released back to the target recipient. For example, assets provided by the target recipient as part of the agreed terms are escrowed assets that are returned back to the target recipient. In various embodiments, the escrowed assets are held by the escrow smart contract and transferred back to a wallet associated with the target recipient. By releasing the escrowed assets back to the buyer, the payment provided by the buyer is transferred to the buyer, reversing any pending payments that were made.

At 607, domain name ownership is reverted back to the owner using the digital token. For example, the owner can reclaim (or unlock) ownership of the off-chain domain name by presenting the digital token returned at 603 to the appropriate DNS registrar. In various embodiments, once the DNS registrar validates the digital token and its ownership, ownership of the off-chain domain name can be assigned back to the owner. In some embodiments, the ownership is only locked during escrow (rather than transferring ownership to the escrow smart contract) and the rights that were locked are now unlocked.

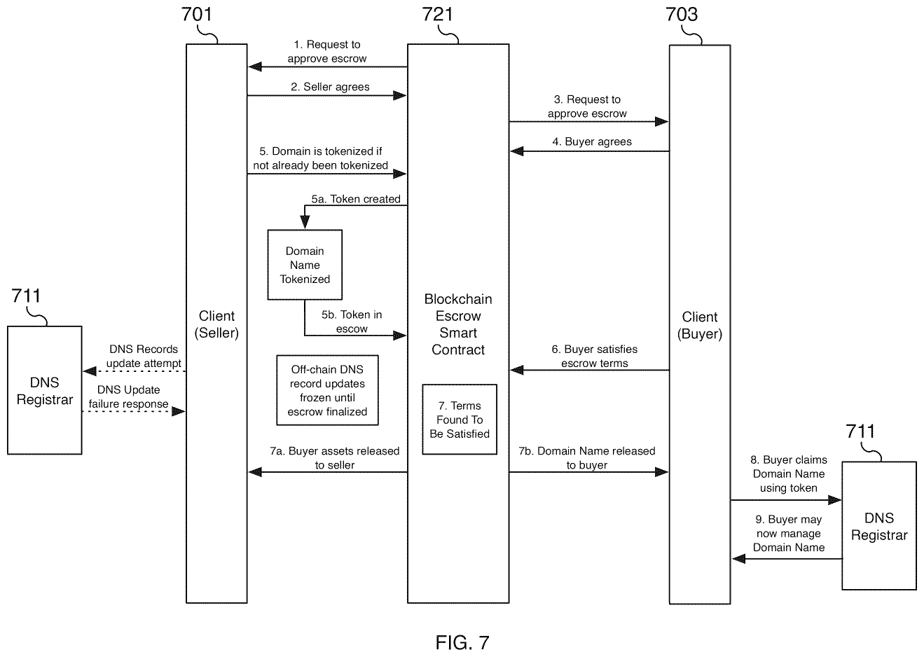

FIG. 7 is a sequence diagram illustrating an embodiment of a process for closing a digital escrow using a blockchain-based digital escrow service. In various embodiments, the process shown in FIG. 7 corresponds to the escrow closing process once parties have agreed to terms of the transaction and utilizes an escrow smart contract of a blockchain-based digital escrow service to complete the transaction. In the example shown, client 701 corresponds to a seller and client 703 corresponds to a buyer of the agreed to transaction. Clients 701 and 703 utilize blockchain escrow smart contract 721 to perform a digital escrow for a domain name registered and managed via DNS registrar 711. In some embodiments, client 701 is client 101 of FIG. 1, client 703 is client 103 of FIG. 1, DNS registrar 711 is DNS registrar 111 of FIG. 1, and/or blockchain escrow smart contract 721 is the escrow smart contract of blockchain 131 of FIG. 1. In some embodiments, blockchain escrow smart contract 721 is the escrow smart contract of blockchain-based digital escrow service 121 of FIG. 1 and/or blockchain-based digital escrow service 201 of FIG. 2. In some embodiments, the sequence shown in FIG. 7 corresponds to the processes described with respect to FIGS. 3-6.

In the sequence diagram of FIG. 7, the steps to transferring an off-chain domain name using a blockchain-based escrow service are numbered in order, starting with step 1 and ending at step 9, and flow from the top of the diagram downwards. As shown in FIG. 7, the process begins at step 1 with client 701, the seller of the domain name, receiving a request from blockchain escrow smart contract 721 to approve the digital escrow. At step 2, the seller agrees to proceed with the agreed terms and does so by providing a cryptographically signed acknowledgement of and authorization to the transaction. At step 3, client 703, the buyer of the domain name, receives a request from blockchain escrow smart contract 721 to approve the digital escrow. At step 4, the buyer agrees to proceed with the agreed terms and can do so by providing a corresponding cryptographically signed acknowledgement of and authorization to the transaction. At step 5, aspects of the off-chain domain name are presented to blockchain escrow smart contract 721 to determine whether an on-chain representation of the off-chain domain name exists. In the event the domain name is not already tokenized, the off-chain domain name is tokenized at steps 5a and 5b. At this point, the digital token is now owned by blockchain escrow smart contract 721 and the off-chain domain name is now locked, freezing off-chain DNS record updates until the escrow is finalized. The failed DNS record update attempt shown on the right side of FIG. 7 confirms that the domain name is locked and that it cannot be transferred to another party until the escrow is finalized. At step 6, the buyer satisfies the escrow terms, triggering blockchain escrow smart contract 721 at step 7 to verify that the terms have been met. Once the escrow terms are confirmed as satisfied, blockchain escrow smart contract 721 executes additional actions corresponding to steps 7a and 7b. At step 7a, the buyer's assets (such as the buyer's payment intended for the seller) are released to the seller, and at step 7b, the domain name is released to the buyer by providing the buyer with ownership of the digital token. In some embodiments, steps 7a and 7b can be performed in parallel. In some embodiments, steps 7a and 7b can be performed sequentially and may be performed in either order. After receiving the digital token, at step 8, the buyer claims the off-chain domain name using the digital token through DNS registrar 711. At step 9, DNS registrar 711 grants the buyer management rights over the domain name.

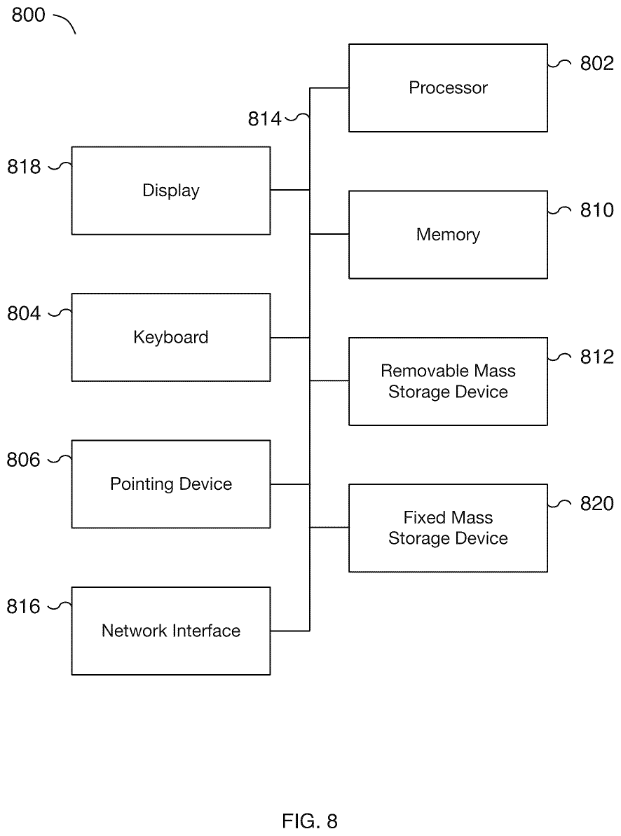

FIG. 8 is a functional diagram illustrating a programmed computer system for securing and efficiently escrowing an off-chain asset using a blockchain-based digital escrow service. As will be apparent, other computer system architectures and configurations can be utilized for implementing a blockchain-based digital escrow service. Examples of computer system 800 include clients 101 and 103 of FIG. 1, one or more computers of DNS registrar 111 of FIG. 1, one or more computers of blockchain-based digital escrow service 121 of FIG. 1, one or more computers included in blockchain 131 of FIG. 1, and one or more computers of blockchain-based digital escrow service 201 of FIG. 2. Additional examples of computer system 800 include clients 701 and 703 of FIG. 7, one or more computers of DNS registrar 711 of FIG. 7, and/or one or more computers used to implement blockchain escrow smart contract 721 of FIG. 7. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 3-7.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a request to establish a digital escrow for a transfer of a domain name;
implementing a blockchain smart contract for the transfer;
receiving a first cryptographically signed authorization associated with a registered owner of the domain name;
receiving a second cryptographically signed authorization associated with a target recipient of the domain name;
placing a digital token associated with the domain name in the digital escrow;
automatically detecting that one or more terms of the blockchain smart contract has been satisfied; and
in response to detecting that the one or more terms of the blockchain smart contract has been satisfied, releasing the digital token associated with the domain name in the digital escrow to the target recipient of the domain name.

2. The method of claim 1, wherein placing the digital token associated with the domain name in the digital escrow includes minting the digital token on a blockchain associated with the blockchain smart contract.

3. The method of claim 1, wherein placing the digital token associated with the domain name in the digital escrow includes assigning ownership control of the digital token to the blockchain smart contract.

4. The method of claim 1, further comprising receiving one or more cryptocurrency payments from the target recipient of the domain name.

5. The method of claim 4, wherein the one or more cryptocurrency payments received from the target recipient of the domain name are held using the blockchain smart contract.

6. The method of claim 4, further comprising in response to detecting that the one or more terms of the blockchain smart contract has been satisfied, releasing the one or more cryptocurrency payments from the target recipient of the domain name to the registered owner of the domain name.

7. The method of claim 1, wherein the digital token associated with the domain name is used to claim a right associated with the domain name from a Domain Name System (DNS) registrar.

8. The method of claim 7, wherein the right associated with the domain name is an ownership right.

9. The method of claim 7, wherein the right associated with the domain name is a right to modify Domain Name System (DNS) records associated with the domain name.

10. The method of claim 1, wherein at least one of the one or more terms of the blockchain smart contract is associated with a time constraint.

11. The method of claim 10, wherein the time constraint specifies a time requirement for completing the digital escrow for the transfer of the domain name.

12. The method of claim 10, wherein the time constraint specifies a lease arrangement for a right associated with the domain name.

13. A system, comprising:
one or more processors configured to:
receive a request to establish a digital escrow for a transfer of a domain name;
implement a blockchain smart contract for the transfer;
receive a first cryptographically signed authorization associated with a registered owner of the domain name;
receive a second cryptographically signed authorization associated with a target recipient of the domain name;
place a digital token associated with the domain name in the digital escrow;
automatically detect that one or more terms of the blockchain smart contract has been satisfied; and
in response to detecting that the one or more terms of the blockchain smart contract has been satisfied, release the digital token associated with the domain name in the digital escrow to the target recipient of the domain name; and
a memory coupled to the one or more processors, wherein the memory is configured to provide the one or more processors with instructions.

14. The system of claim 13, wherein being configured to place the digital token associated with the domain name in the digital escrow includes being configured to mint the digital token on a blockchain associated with the blockchain smart contract.

15. The system of claim 13, wherein being configured to place the digital token associated with the domain name in the digital escrow includes being configured to assign ownership control of the digital token to the blockchain smart contract.

16. The system of claim 13, wherein the one or more processors are further configured to receive one or more cryptocurrency payments from the target recipient of the domain name.

17. The system of claim 16, wherein the one or more cryptocurrency payments received from the target recipient of the domain name are held using the blockchain smart contract.

18. The system of claim 16, wherein the one or more processors are configured to: in response to detecting that the one or more terms of the blockchain smart contract has been satisfied, release the one or more cryptocurrency payments from the target recipient of the domain name to the registered owner of the domain name.

19. The system of claim 13, wherein the digital token associated with the domain name is used to claim a right associated with the domain name from a Domain Name System (DNS) registrar.

20. A computer program product, the computer program product being embodied in a non-transitory computer readable storage medium and comprising computer instructions for:
receiving a request to establish a digital escrow for a transfer of a domain name;
implementing a blockchain smart contract for the transfer;
receiving a first cryptographically signed authorization associated with a registered owner of the domain name;
receiving a second cryptographically signed authorization associated with a target recipient of the domain name;
placing a digital token associated with the domain name in the digital escrow;
automatically detecting that one or more terms of the blockchain smart contract has been satisfied; and
in response to detecting that the one or more terms of the blockchain smart contract has been satisfied, releasing the digital token associated with the domain name in the digital escrow to the target recipient of the domain name.
